(19) United States
(12) Patent Application Publication
(10) Pub. No.: US 2009/0257416 A1
(43) Pub. Date: Oct. 15, 2009

(54) ACCESS POINT

(75) Inventors: Mark Walker, Wiltshire (GB); Peter Keevill, Bath (GB); Andrea Giustina, Milan (IT); Uthay Thana, Essex (GB)

Correspondence Address: Weaver Austin Villeneuve & Sampson LLP, P.O. BOX 70250, OAKLAND, CA, 94612-0250, US

(73) Assignee: UBIQUISYS LIMITED, Wiltshire (GB)

(21) Appl. No.: 12/418,517

(22) Filed: Apr. 3, 2009

(30) Foreign Application Priority Data
Apr. 9, 2008 (GB) 0806446.1

(51) Int. Cl. H04W 84/02

(52) U.S. Cl. 370/338

(57) ABSTRACT

An access point has a connection to a wide area network, and is configured to allow a device to connect thereto, and includes an Application Programming Interface for allowing a remote application to connect to the access point over the wide area network, and to obtain information relating to the device connected to the access point. In particular, the access point is configured to allow a device to connect thereto over a wireless interface, and to provide bearer translation such that traffic over the wireless interface can be directed over the wide area network. The Application Programming Interface may then allow the application to obtain information relating to a connection status of a wireless device associated with the access point.

### CROSS-REFERENCE TO RELATED APPLICATION

This application claims priority of U.K. Patent Application No. 0806446.1, filed on Apr. 9, 2008, which is hereby incorporated by reference.

It is proposed to use an access point to provide services to a user of a telecommunications device. The access point can take the form of a femtocell basestation, that is, a basestation that acts to provide conventional telecommunications coverage for at least some devices when they are within the (normally short) range of the basestation. In this way, the femtocell basestation acts as a conventional basestation within a cellular network, albeit only providing coverage within a small area, which may be the user's home or office, and being able to limit the devices that can access the network in this way, for example to the user's own devices, or to other devices that have been specifically permitted to gain access. The femtocell basestation uses the user's existing broadband internet connection to pass data to and from the cellular network operator's core network, reducing the need for the network operator to build infrastructure to serve that basestation.

As the femtocell basestation connects to the internet, to the user's local network, and to the cellular network, and the user's mobile device or devices can be expected to establish contact with it at regular intervals, it provides an opportunity to deliver additional services to the user.

The present invention relates to an access point architecture that allows such additional services to be delivered.

According to an aspect of the present invention, there is provided an access point, having a connection to a wide area network, and being configured to allow a device to connect thereto, and comprising an Application Programming Interface for allowing a remote application to connect to the access point over the wide area network, and to obtain information relating to the device connected to the access point.

According to a second aspect of the present invention, there is provided an access point, having a connection to a wide area network, and being configured to allow a device to connect thereto over a wireless interface, and to provide bearer translation such that traffic over the wireless interface can be directed over the wide area network, the access point further comprising an Application Programming Interface for allowing an application to connect to the access point, and to obtain information relating to a connection status of a device associated with the access point.

According to a third aspect of the present invention, there is provided a core network node, connected over a wide area network to a plurality of access points, wherein the core network node comprises a database linking each of a plurality of wireless device identities to at least one respective access point of said plurality of access points, and containing an updatable IP address for each of said access points, and wherein, in response to a query from an application referring to a wireless device identity, the core network node supplies said updatable IP address for the access point linked to the wireless device identity.

For a better understanding of the present invention, reference will now be made to the accompanying drawings, in which:—

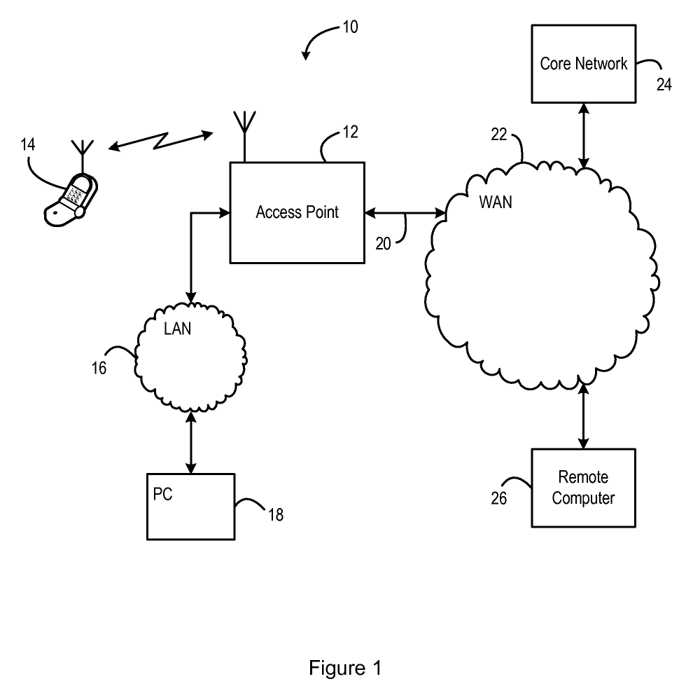

FIG. 1 is a schematic diagram of a part of a communications network in accordance with an aspect of the invention.

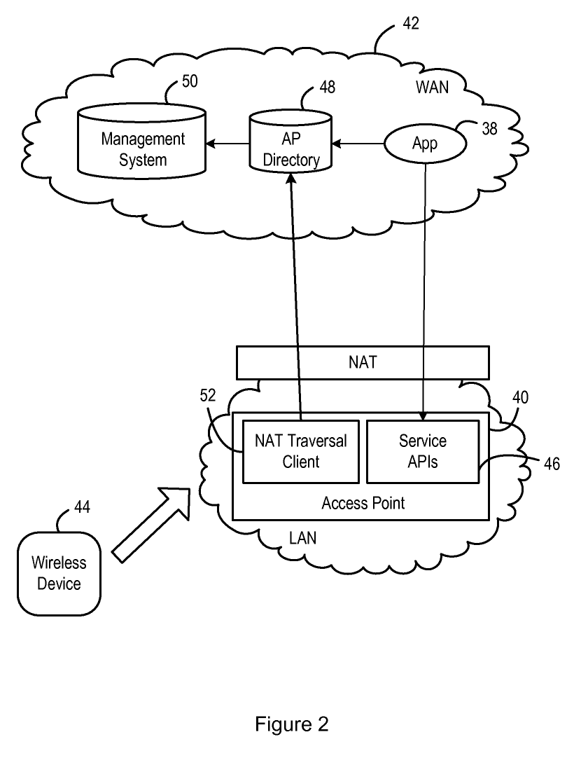

FIG. 2 illustrates an operation of an access point in the network of FIG. 1.

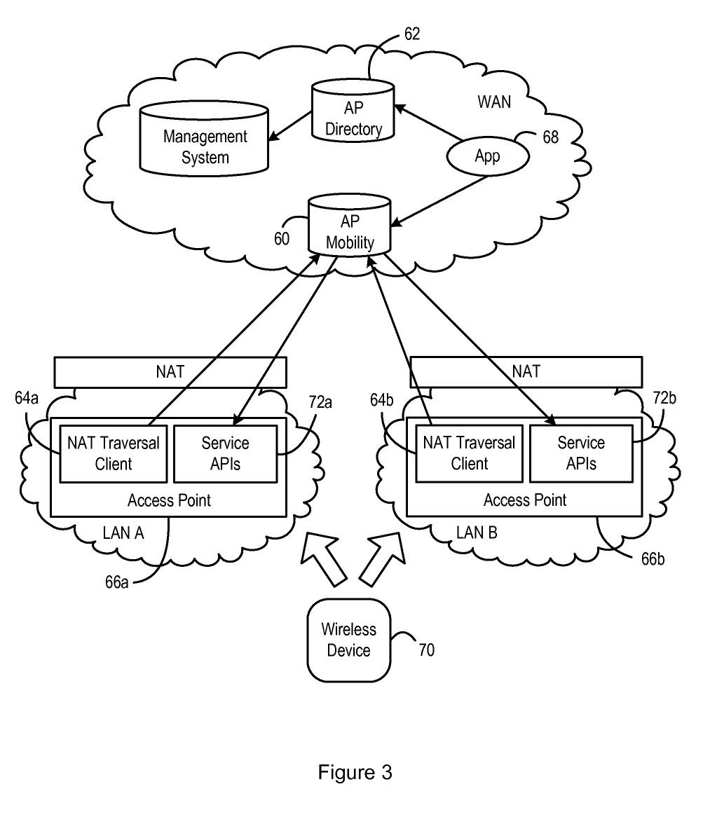

FIG. 3 illustrates an alternative operation of an access point in the network of FIG. 1.

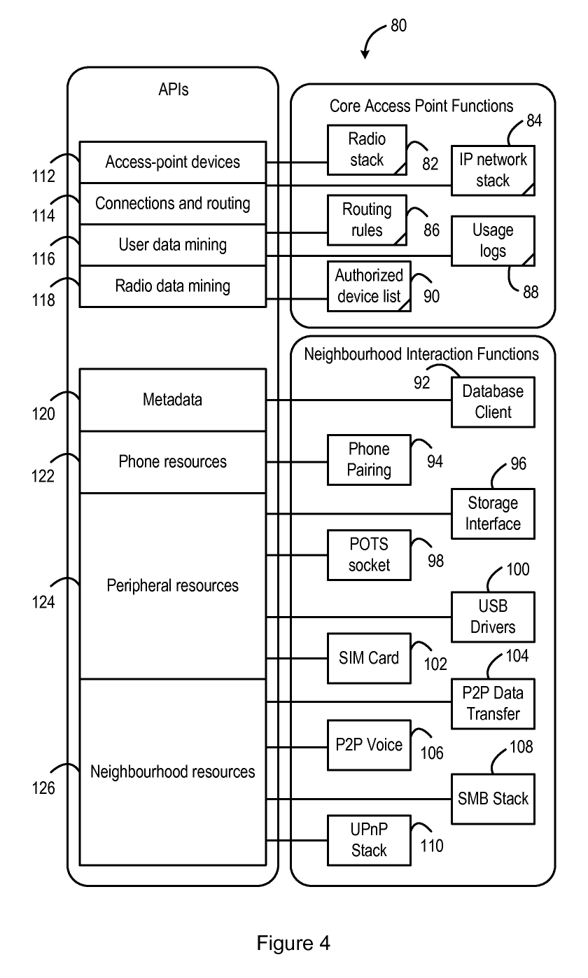

FIG. 4 is a schematic diagram illustrating an access point in accordance with an aspect of the invention.

FIG. 1 shows a part of a communications network in accordance with the present invention. In particular, FIG. 1 shows an access point 12, and its position at the interconnection of multiple networks.

Thus, the access point 12 acts as a wireless basestation, allowing a wireless device 14 to establish a connection to it. In one preferred embodiment, the access point 12 acts as a cellular basestation, forming part of a cellular communications network, such that the wireless device 14 can roam from the basestation to other basestations having adjacent or overlapping coverage areas, and such that existing wireless devices can operate with the basestation without modification. In other embodiments, the access point 12 can act as a WiFi (IEEE 802.11x) or Bluetooth access point.

The access point may also act as a node in a Local Area Network (LAN) 16, for example within a customer's home or business premises. One or more personal computers, such as the personal computer (PC) 18, or other devices, can ten be connected through the LAN 16 to the access point 12.

As illustrated, the access point 12 also has a connection, in this case over the customer's existing broadband connection 20, to a wide area network (WAN) 22, such as the internet. With appropriate authentication, this allows a connection to be established into, for example, a core network 24 of a mobile communications network. When the access point is acting as a cellular basestation, this connection provides the backhaul for the cellular traffic into the cellular network.

The connection to the internet also allows the access point 12 in principle to connect to any remote computer that also has an internet connection. The position of the access point 12 enables various connections. Thus, it enables wireless devices such as devices 14 to connect to a network, by providing a local area of wireless coverage within which connections may be made over a radio bearer between the wireless device 14 and the access point 12.

In general terms, an access point is part of a computer network, typically interconnected over a different wired, wireless or tunnelled bearer. The access point enables wireless devices to connect to the network by authenticating the wireless device with the network, manifesting a network address within the network for the wireless device so that connections can be established and data routed between it and other devices in the network, and performing bearer transformation for the data being carried between the wireless device and other devices in the network (which may extend to include QoS management, power management etc).

In a general sense, a particular manifestation of an access point may provide an area of coverage for one or more wireless technologies (802.11x WiFi, Cellular, Bluetooth etc) and connect into one or more networks (LAN, MAN, cellular core, WAN/Internet etc). Thus, the access point performs bearer translation between the radio interface and the network interface. For each pairing of radio bearer and network required by the wireless device the access point preferably also performs authentication and provides a network address and connectivity.

Common manifestations of access points include a WiFi (802.11b/g) access point into a LAN, a Bluetooth access point into a LAN, a 3G cellular (UMTS or EVDO) femtocell tunnelling through a broadband access network into a mobile core network (and optionally, as shown in FIG. 1, providing additional connectivity for devices into a local LAN and the Internet), and an Integrated Home Gateway access point supporting simultaneous WiFi and cellular radio access into multiple networks.

Considering the client-server model of networked computers, an access point mostly functions as a transparent transport device, and is neither client nor server in terms of actively requesting or providing data or capability to fulfil a user application. However, an access point may be a client of an authentication server when it joins the network to which it will provide access for wireless devices, and an access point may be a server, publishing a user interface to a client (typically a web browser) for the purpose of administering the configuration of the access point.

In embodiments of the present invention, there is defined a different role for an access point, namely as a server, making available one or more Application Programming Interface (API) through which client computers and devices may interact with the internal state, events and actions of the access point, and/or the internal state, events and actions of any peripheral capabilities within the physical access point device, and/or the internal state, events and actions of wireless devices connected to access point, and/or the internal state, events and actions of devices within the same network(s) as the access point.

It will be noted that, in general terms, a software application that is running on a client computer in order to provide a service will need to establish connections to a large number of access points, in order to be able to provide the service to the population of subscribing wireless devices connected to those wireless devices.

In addition, where the access point forms part of a cellular communications network, and uses the internet or another public wide area network for backhaul of traffic between the access point and the core network, it is the cellular network which authenticates the access point in order to allow the traffic to access the core network.

In embodiments of the invention, the software application will be run not by the cellular network operator, but by a third party, who will need to be appropriately delegated by the cellular network operator. The cellular network operator then provides an architecture that allows the third party application to determine the location of a particular device, and to communicate with the appropriate API on the access point serving that device.

The API, or each of the APIs, is implemented by software running on the access point device. In general terms, the API is able to query or set some system state, and/or read or write data to non-volatile storage, and/or register to be notified of subsequent events, and/or query or set rules governing behaviour by which the access point responds to subsequent events, and/or initiate some system activity, and/or aggregate sequences of such methods.

A software application can then be provided, querying the API in order to obtain some information that is used by the application while it is running. In principle, a software application of this type can be running on the access point, or on a wireless device connected to the access point, or on a device such as a PC in the same LAN as the access point, or on a device having a connection to the access point over a private wide area network, or on a device having a connection to the access point over a public wide area network. For the purposes of illustration, the invention will mainly be described with reference to examples of applications running on remote devices connected to the access device over the internet.

FIG. 2 illustrates in general terms how an access point in accordance with the invention can allow an application to provide a service to a wireless device.

In FIG. 2, an application (App) 38, located remote from the access point 40 over a WAN 42 is providing a service to a wireless device 44. The wireless device 44 connects through a single “home” access point 40 to get service, and the application uses APIs 46 on the access point 40 to compose, customise or contextualise the service it provides. The application 38 needs to get connected to the APIs 46 of the access point 40 serving the wireless device 44.

In order for this to happen, a directory service 48 must be provisioned with the static relationship between wireless device identities and the identity of the “home” access point 40 which provides service to that wireless device 44. Typically this data will be held in a service provider's management system 50. The access point NAT traversal client 52 updates the directory 48 with a routable IP address for its identity. This could happen relatively frequently, as the access point's private address and the NAT router's public address will often be assigned volatile IP addresses which change after reboot.

In order to provide the service, the application 38 makes a discovery query on the directory 48, passing in a wireless device identity and receiving a returned routable IP address for the access point 40. The application 38 can then connect to the APIs 46 on the access point 40 serving the wireless device 44 it is interested in, and uses them as required.

FIG. 3 illustrates in general terms how an access point in accordance with the invention can allow an application to provide a service to a wireless device, in the situation where the wireless device can be served by multiple access points.

Where there are a small number of such access points, for example at the user's home and office locations, a directory can simply return a set of API locations when queried for a device. However, where there are open/public access points, such as those provided by a hotspot operator or a by a sharing community, a mobility infrastructure is more suitable.

As shown in FIG. 3, a mobility service 60 works alongside the directory 62 providing complementary functions. The directory service 62 is provisioned with the static relationship between wireless device identity and its access rights for the population of access points. The NAT traversal clients 64a, 64b in all access points, such as the access points 66a, 66b, update the mobility service 60 with routable IP addresses for their identities. They also update the mobility service 60 with the list of wireless devices which are attached to them.

When an application 68 wishes to provide a service to a wireless device 70, it makes a discovery query on the directory 62, passing in the identity of the wireless device 70, and receiving in return a routable IP address. While this may as before be a direct link to a single “home” access point, it could be an address at the mobility server 60 which acts as a Mobile-IP type home agent.

The application 68 then connects to the APIs 72a or 72b serving the wireless device 70, and uses them as required. If the application has been given an API address that resides on the mobility server 60, the API messages are routed by the mobility server 60 to the access point 66a or 66b serving the wireless device 70 at that time. This is transparent to the application 68, and API access is continuous without recourse to the directory service while the wireless device 70 moves between access points.

FIG. 4 is a schematic diagram, illustrating in more detail an access point 80 in accordance with the present invention.

The access point 80 has software that provides its functionality relating to the provision of a wireless (e.g. cellular) service to a mobile communications device that can be connected thereto over a wireless interface, and using an IP network for backhaul to the wireless network operator's core network. This includes at least the radio stack 82, the IP network stack 84, its routing rules 86, its usage logs 88, and an authorized device list 90.

The access point 80 has software that provides its functionality relating to neighbourhood interactions, such as interacting with and interfacing to other devices on the LAN, or to other devices that may be connected directly or indirectly to it, be they other modules or peripherals of the same physical electronic device, attached wireless devices, or devices in the same network neighbourhood. This may for example include at least a database client 92, phone pairing software 94, a storage interface 96, a POTS socket 98, USB drivers 100, a SIM card interface 102, P2P data transfer software 104, P2P voice transfer software 106, an SMB stack 108, and a UpnP stack 110.

The core access point functions can be exposed through a primary set of APIs, related to the core role of the access point and the knowledge it can derive from radio activity. For example, an API 112 related to wireless devices is able to query the set of phones authorized to use the access point; query which phones are presently attached; register for notification when phones join and leave the access point.

An API 114 concerned with connections and routing is able to query device connection status (idle, in call, active data session) and register for notification of status changes; set routing rules such as short-code substitutions tables for click-to-dial links inserted into a webpage; register to connection requests for particular types of network traffic and instruct the access point on how to proceed.

An API 116 concerned with user data mining is able to obtain an activity history.

An API 118 concerned with radio data mining is able to obtain metrics about the radio environment.

Other APIs help developers targeting data services at wireless devices.

An API 120 concerned with metadata is able to obtain data which the access point or a service provider holds about the specific deployment instance: owner information; device hardware/software profile; access point geo-location; access point API capability negotiation (different models of access point may support differing subsets of the potential APIs)

An API 122 concerned with wireless device resources (only applicable when the access point can autonomously initiate a data session with the wireless device, such as a 3G cellular access point), by running a small secure “phone pairing” client on the wireless device, can mediate access to the internal resources of the wireless device: available storage; storage read/write; battery/charging status; user activity status; user notification/alerting; software installation and management. This enables subscription-type services to update the handset when it is in range of the access point without user involvement.

Other APIs exploit the always-on physical presence of the access point in the LAN, using it as a gateway to gain access to neighbouring resources. By implementing additional protocols the access point can interact with shared storage, sensors and actuators in the LAN, and P2P devices and other services in the Internet.

An API 124 concerned with peripheral resources can obtain secure access to integrated peripherals in an integrated home-gateway that includes the access point, for example such as landline phones attached to POTS ports; USB-attached storage and printers; or a SIM card.

Similarly, an API 126 concerned with neighbourhood resources can obtain secure access to other devices connected to the LAN, such as media storage and playback devices, and can thus perform content directory browsing of DLNA media centre; directing media to be rendered at a UPnP TV or hi-fi; accessing a Windows file share on a PC or NAS. Another such API concerned with LAN telephony can obtain a list of VoIP devices in the LAN registered with the access point, and their status. Another such API concerned with P2P telephony can obtain a list of Internet telephony devices manifested at the access point and their status.

While APIs on access points will provide the building blocks for services, a supporting operational infrastructure is required to deliver the benefits. Applications hosted in the LAN, service provider core or Internet need to discover and connect to the access point which serves the mobile devices of a particular consumer. Third-party access to the access point (and by extension handsets, home network devices and service provider resources) must be tightly controlled by the service provider, establishing a chain of trust that protects the consumer from malicious software and enables revenue to be apportioned in the value chain.

In the wider field of computer networks, applications built using remote APIs are commonplace. In the telecoms domain, architectures such as OSA/Parlay provide APIs for creating mobile applications, and on the web e-commerce and mashup sites routinely use APIs to leverage capabilities hosted by Paypal, Amazon, Google and many others. Typically the APIs used to build Internet services are hosted on large server clusters, load-balanced behind a public static IP address which can be discovered with a standard DNS lookup.

In accordance with the present invention, access point hosted APIs invert this network topology. Although applications will often reside on large servers, the APIs are hosted on a huge population of access points at the edge of the network, hidden behind NAT devices and assigned transient private IP addresses. In this respect, discovery and routing to an access point API is similar to a P2P client attempting to connect to one of its peers, and the techniques for NAT traversal and dynamic device registration pioneered by software like Skype can be applied. Protocols such as STUN, TURN and IGD can be used to traverse NAT devices and firewalls, and techniques similar to Interactive Connectivity Establishment (ICE) can be employed to negotiate the most efficient NAT traversal for deployed location of a particular access point.

In connection with FIG. 4 above, there were described in general terms some of the information that might be made available by an API to an application.

More specifically, an access point API may exposes the state and actions associated with the set of wireless devices that use the access point to connect to the network, thus providing, for example:
a method to query if the access point is “open” such that any device may use it to connect;
a method to query if the access point is “closed” such that only a set of devices with predefined identities may use it to connect;
a method to obtain a list of the devices authorised to use the access point (in this case the devices would preferably be identified by static identifiers such as their MSISDN, rather than by an IP address which would be a temporary and transient identity);
a method to obtain a list of the devices currently attached to the access point;
a method to register for events as devices attach and detach to the access point, and for notification when such events occur (where “attached” means the wireless device is within coverage of the access point and the access point is aware of it and has authenticated and authorised it, although the device does not necessarily have an active IP context).

Also, an access point API may expose the state and actions associated with the network connections of specific wireless devices that are associated with the access point. Thus, for example, an API might expose whether a device is attached to or detached from the access point. Further, the API might expose about a connection status of a specific attached device. For example, it might indicate whether the device is in idle mode or in a call or data session. Alternatively, it might indicate whether the device is disconnected, on standby, or connected, depending on the device class, the radio technology and the link power management capabilities.

Based on this, it may be possible to:
bridge a telephony (voice or video) call leg between the phone and the access point with one between the access point and PSTN/mobile core;
bridge a telephony (voice or video) call leg between the phone and the access point with one between the access point and an alternative telephony network such as VoIP or P2P;
initiate direct connections between local devices, for example to create a home intercom service;
create “interrupts” for particular connection attempts, such that the access point makes a callout for instruction on how to proceed when the connection attempt occurs, where examples might include: a parental control service which decides to allow or block each web connection requested from a child's mobile device; a telephone traffic offload service which routes the call P2P if the destination phone is attached to a peer access point; interception of dialled short-code numbers to determine to which real destination and routing they should be transformed.

An API of this type might also be able to determine the make and model of the device, where this can be inferred from the connection (i.e. IMEI in a cellular connection or MAC address in a WiFi connection). Again, this information can be made available by the API to an application running elsewhere.

Another API of this type can expose information about the RF connection between the wireless device and the access point, for example to indicate whether the device is in good coverage.

Also, an access point API can expose the state and actions associated with the capabilities (hardware and software) of wireless devices attached to the access point, for example whether it supports video, or how much memory it has available. An API of this type allows an application to:
query the free/available storage capacity of the device;
reserve storage capacity on the device;
read from the device storage (typically files in a hierarchy of folder locations but possibly some other abstraction such as a database);
write (create or update) to the device storage (typically files in a hierarchy of folder locations but possibly some other abstraction such as a database);
delete from the device storage (typically files in a hierarchy of folder locations but possibly some other abstraction such as a database);
query battery capacity and charging status;
send an SMS or MMS from the device;
initiate a voice or video call from the device;
install, upgrade or delete software on the device;
start and stop software applications/services on the device;
display a status indication or user alert on the device (similar to the “new message” icons commonly displayed on mobile phones);
query user activity (query if the user interface in use rather than a network-based activity, for example user is playing media or typing a message);
query the subset of API capabilities supported by a specific device;
query the manufacturer, model and firmware version of a device.

Also, an access point API can expose metadata associated with the access point and associated wireless devices. Much of this data will be retrieved from external databases within ISP and mobile carrier operational systems and from device manufacturers, and then associated with the access point and devices. An API would thus allow an application to obtain:
owner and household personal, interrelation, and demographic information;
information about the relationships of devices to owners (shared, exclusive ownership etc);
device information such as manufacturer, model, screen size, keyboard/data entry mechanism, audio-visual capabilities, media codecs;
access point address/geo-location.

Also, an access point API can exposes the state and actions associated with integrated peripherals that may exist within the same physical equipment as the access point, this allowing:
reading and writing data to public/shared storage (such as where a home gateway contains both access point and network attached storage (NAS) functions);
using external storage, printers or other peripherals connected via USB, Firewire, PCMCIA, CompactFlash or similar sockets integrated in the same physical device as the access point;
authenticating with a cellular network and accessing network-hosted services using a SIM card integrated in the same physical device as the access point (for example allowing a physical plain old telephony service (POTS) phone connected to a integrated POTS socket or a softphone running on a PC in the LAN to behave as cellular phones);
using the ringer, dialling, microphone and speakers within a POTS phone connected to a POTS socket integrated in the same physical device as the access point.

Also, an access point API can expose the state and actions associated with devices within the same network(s) as the access point, for example allowing:
reading and writing shared storage within the LAN (for example using SMB protocol);
uploading, downloading, serving, playing and controlling digital media in the LAN (for example using UPnP protocols);
downloading appropriately transcoded digital media from a broadcast television set-top box in the LAN (for example using a protocol proprietary to the set-top box vendor);
uploading or downloading digital media (or other data) from a remote device in the Internet (for example using a peer-to-peer transfer protocol such as BitTorrent or a client-server protocol such as FTP).

Also, an access point API can virtualize the contents and capacity of associated mobile devices, for example:
swapping application software installed on the device between “available” (stored locally on the device) and “archived” (stored externally but available to be re-instated whenever the device is attached to the access point) as required while the device is attached to the access point;
swapping content stored on the device between “available” (stored locally on the device) and “archived” (stored externally but available to be re-instated whenever the device is attached to the access point) as required while the device is attached to the access point;
playing a media file by transparent substitution of a streamed and a local file.

Also, an access point API can expose statistics about user history including status of wireless devices and usage of network connections over time.

Also, an access point API can expose statistics about radio environment history, including interference and power levels on its operating frequency and adjacent frequencies.

Preferably, the access point performs NAT translation, such that when it publishes a resource through the API (i.e. storage on a wireless device, or the URL of a media file on a UPnP server) the resource is routable subsequently via the access point.

The invention has been described above with reference to embodiments in which the access point has a wireless interface, and may also have an interface for a local area network. However, the invention is also applicable to other situations, in which the API could be provided on a PC, a router, or a set-top box, for example, and could then allow the remote application to obtain information relating to other devices on the same LAN.

1. An access point, having a connection to a wide area network, and being configured to allow a device to connect thereto, and comprising an Application Programming Interface for allowing a remote application to connect to the access point over the wide area network, and to obtain information relating to the device connected to the access point.

2. An access point as claimed in claim 1, configured to allow a device to connect thereto over a wireless interface.

3. An access point as claimed in claim 2, configured to allow a device to connect thereto over a cellular wireless interface.

4. An access point as claimed in claim 3, configured to transmit and receive traffic from and to the device connected thereto over the wide area network.

5. An access point as claimed in 2, wherein the Application Programming Interface allows the remote application to obtain information relating to the device connected to the access point over the wireless interface.

6. An access point as claimed in claim 5, wherein the Application Programming Interface allows the remote application to obtain information as to whether a specific device is attached to or detached from the access point over the wireless interface.

7. An access point as claimed in claim 6, wherein the Application Programming Interface allows the remote application to obtain information as to whether the specific attached device is in idle mode or is in a call or data session over the wireless interface.

8. An access point as claimed in claim 5, wherein the Application Programming Interface allows the remote application to obtain information relating to capabilities of one or more specific device connected to the access point over the wireless interface.

9. An access point as claimed in claim 5, wherein the Application Programming Interface allows the remote application to obtain information relating to a quality of an RF connection between the access point and one or more specific device connected to the access point over the wireless interface.

10. An access point as claimed in claim 2, wherein the Application Programming Interface allows the remote application to obtain information relating to a set of devices that are permitted to connect to the access point over the wireless interface.

11. An access point as claimed in claim 2, wherein the Application Programming Interface allows the remote application to obtain information relating to network connections of a specific device connected to the access point over the wireless interface.

12. An access point as claimed in claim 1, further configured to allow a device to connect thereto over a local area network, wherein the Application Programming Interface allows the remote application to obtain information relating to the device connected to the access point over the local area network.

13. An access point as claimed in claim 1, having a NAT traversal client, allowing a remote application to obtain the information from the Application Programming Interface.

14. An access point as claimed in claim 1, wherein the application is able to obtain the information from the Application Programming Interface for use while the application is running.

15. An access point as claimed in claim 1, wherein the connection to the wide area network is a connection to a public wide area network.

16. An access point as claimed in claim 15, wherein the public wide area network is the internet.

17. An access point, having a connection to a wide area network, and being configured to allow a device to connect thereto over a wireless interface, and to provide bearer translation such that traffic over the wireless interface can be directed over the wide area network, the access point further comprising an Application Programming Interface for allowing an application to connect to the access point, and to obtain information relating to a connection status of a device associated with the access point.

18. An access point as claimed in claim 17, wherein the information relating to the connection status of the device associated with the access point comprises information as to whether a specific device is attached to or detached from the access point.

19. An access point as claimed in claim 17, wherein the information relating to the connection status of the device associated with the access point comprises information as to whether the device is in idle mode or is in a call or data session.

20. An access point as claimed in claim 17, wherein the information relating to the connection status of the device associated with the access point comprises information relating to an RF connection between the device and the access point.

21. A core network node, connected over a wide area network to a plurality of access points, wherein the core network node comprises a database linking each of a plurality of wireless device identities to at least one respective access point of said plurality of access points, and containing an updatable IP address for each of said access points, and wherein, in response to a query from an application referring to a wireless device identity, the core network node supplies said updatable IP address for the access point linked to the wireless device identity.

22. A core network node as claimed in claim 22 wherein, when a wireless device may be connected to a plurality of said access points, the core network node supplies an IP address of a mobility server, which is in turn able to direct a message from the application to an appropriate one of said plurality of said access points.
